(19) United States
(12) Patent Application Publication
(10) Pub. No.: US 2026/0321819 A1
(43) Pub. Date: Oct. 15, 2026

(54) BATTERY MODULE AND BATTERY APPARATUS

(71) Applicant: BYD COMPANY LIMITED, Shenzhen (CN)

(72) Inventors: Wenhao ZHANG, Shenzhen (CN); Min TONG, Shenzhen (CN); Ye TIAN, Shenzhen (CN); Chao LI, Shenzhen (CN); Gengchen WU, Shenzhen (CN)

(21) Appl. No.: 19/532,325

(22) Filed: Feb. 6, 2026

Related U.S. Application Data
(63) Continuation of application No. PCT/CN2024/083069, filed on Mar. 21, 2024.

(30) Foreign Application Priority Data
Aug. 7, 2023 (CN) 202310989968.0

(51) Int. Cl. H01M 50/136; H01M 50/129; H02S 30/00

(52) U.S. Cl. CPC H01M 50/136; H01M 50/129; H02S 30/00

(57) ABSTRACT

In one aspect, a battery assembly includes a first flexible material layer, a second flexible material layer, and a battery layer. The battery layer includes a plurality of battery bodies disposed at intervals, and the battery layer is located between the first flexible material layer and the second flexible material layer. The first flexible material layer and the second flexible material layer form a flexible region at a gap between adjacent battery bodies, the second flexible material layer is configured to be connected to a component to be mounted, and the flexible region is adapted to a bent portion of the component to be mounted.

### CROSS-REFERENCE TO RELATED APPLICATIONS

The present disclosure is a bypass continuation of International Patent Application No. PCT/CN2024/083069, filed on Mar. 21, 2024, which in turn claims priority to Patent Application No. 202310989968.0, filed on Aug. 7, 2023 and entitled “BATTERY ASSEMBLY AND BATTERY APPARATUS”, both of which are hereby incorporated herein by reference in their entirety for all purposes.

### TECHNICAL FIELD

The present disclosure relates to the field of battery technologies, and, in particular, to a battery assembly and a battery apparatus.

### BACKGROUND

A power generation assembly, such as a photovoltaic power generation assembly, generally includes solar panels and a support. The solar panels are connected together through the support to form an integral planar structure. During assembly, the support is mounted to a component to be mounted, such as a roof, through a clamp. An existing photovoltaic power generation assembly has a complex structure and high requirements for structural strength of the support, resulting in significant weight.

Therefore, a new technical solution needs to be provided to resolve the foregoing technical problem.

### SUMMARY

The present disclosure provides a new technical solution of a battery assembly.

According to a first aspect of the present disclosure, a battery assembly is provided. The battery assembly includes a first flexible material layer, a second flexible material layer, and a battery layer. The battery layer includes a plurality of battery bodies disposed at intervals, and the battery layer is located between the first flexible material layer and the second flexible material layer. The first flexible material layer and the second flexible material layer form a flexible region at a gap between adjacent battery bodies, the second flexible material layer is configured to be connected to a component to be mounted, and the flexible region is adapted to a bent portion of the component to be mounted.

In some embodiments, at least one of the first flexible material layer or the second flexible material layer is provided with a bonding layer on a side closest to the battery layer.

In some embodiments, at least one of the first flexible material layer or the second flexible material layer includes at least one of a fiber material layer, a polymer layer, a glass layer, or a metal film layer.

In some embodiments, at least one of the first flexible material layer or the second flexible material layer includes a polymer layer, and the polymer layer includes a fluoropolymer.

In some embodiments, the battery assembly further includes a reinforcing layer, and the reinforcing layer is located between the first flexible material layer and the battery body.

In some embodiments, the reinforcing layer includes a fiber material layer.

In some embodiments, the battery body is made of a photovoltaic material, the first flexible material layer forms a functional region at a position opposite to the photovoltaic material, and a light transmittance of the functional region is greater than or equal to 80%.

In some embodiments, the battery body is made of a photovoltaic material, a reflectivity of the flexible region of the first flexible material layer is greater than or equal to 80%, and the flexible region is adapted to reflect light onto the photovoltaic material.

In some embodiments, the flexible region of the first flexible material layer includes a base body layer and a reflective coating disposed on the base body layer.

In some embodiments, the base body layer includes at least one of a fiber material layer, a polymer layer, a glass layer, or a metal film layer.

In some embodiments, the reflective coating includes at least one of acrylic resin, silicone-modified acrylic resin, alkyd resin, silicone-modified alkyd resin, fluorine-containing resin, epoxy resin, or chlorinated rubber; or
the reflective coating includes at least one of acrylic resin, silicone-modified acrylic resin, alkyd resin, silicone-modified alkyd resin, fluorine-containing resin, epoxy resin, or chlorinated rubber, and a mixture of at least one of titanium dioxide, talc, calcium carbonate, silicon dioxide, or metal powder.

In some embodiments, a thickness of at least one of the first flexible material layer or the second flexible material layer ranges from 0.2 mm to 0.5 mm.

According to a second aspect of the present disclosure, a battery apparatus is provided. The battery apparatus includes the foregoing battery assembly.

In some embodiments, the battery apparatus further includes a substrate. The substrate includes a plurality of surfaces, and a bent portion is formed between the plurality of surfaces. The battery bodies are located on the plurality of surfaces, and the flexible region is located on the bent portion.

In some embodiments, a first protrusion portion is formed between two adjacent surfaces, the first protrusion portion includes a plurality of bent portions, and the flexible region covers the first protrusion portion.

In some embodiments, the flexible region is of an arc surface structure.

In some embodiments, the substrate includes a second protrusion portion and a recessed portion. The plurality of surfaces include a top surface located on the second protrusion portion, a bottom surface located at a bottom of the recessed portion, and a side surface between the top surface and the bottom surface. A connection between the top surface and the side surface and a connection between the bottom surface and the side surface separately form the bent portion. The battery layer includes a plurality of battery bodies, and the plurality of battery bodies are respectively located on the top surface, the bottom surface, and the side surface.

In some embodiments, the substrate includes a second protrusion portion and a recessed portion. The plurality of surfaces include a top surface located on the second protrusion portion and a side surface located on the recessed portion. A connection between the top surface and the side surface and a connection between two adjacent side surfaces separately form the bent portion. The battery layer includes a plurality of battery bodies, and the plurality of battery bodies are respectively located on the top surface and the side surface.

In some embodiments, the substrate includes a second protrusion portion and a recessed portion. The plurality of surfaces include a bottom surface located at a bottom of the recessed portion and a side surface located on the recessed portion. A connection between the bottom surface and the side surface and a connection between two adjacent side surfaces separately form the bent portion. The battery layer includes a plurality of battery bodies, and the plurality of battery bodies are respectively located on the bottom surface and the side surface.

In some embodiments, edges of the first flexible material layer and the second flexible material layer can be bent to cover an edge of the substrate.

In some embodiments, the substrate includes a color steel plate.

In an embodiment of the present disclosure, the battery assembly has a simple structure. When the battery assembly is mounted, the battery assembly can be directly attached to a surface of the component to be mounted, without the need to provide an additional support to support the battery assembly. This reduces a weight of the battery assembly.

In addition, the battery assembly has a flexible region. In the flexible region, the first flexible material layer and the second flexible material layer can be bent, so that the battery assembly can adapt to the bent portion of the component to be mounted. This increases a contact area between the battery assembly and the component to be mounted. A gap between the battery assembly and the component to be mounted is significantly reduced, making it less likely for the battery assembly to be suspended in mid-air. This enables connection between the battery assembly and the component to be mounted to be more secure.

Other features and advantages of the present disclosure will become clear from the following detailed description of the exemplary embodiments of the present disclosure with reference to the accompanying drawings.

### BRIEF DESCRIPTION OF DRAWINGS

The accompanying drawings which are incorporated in the specification and constitute a part of the specification illustrate embodiments of the present disclosure, and are used to explain the principles of the present disclosure together with the descriptions of the embodiments.

FIG. 1 is a schematic diagram of a structure of a power generation assembly according to an embodiment of the present disclosure;

FIG. 2 is an assembly diagram of a power generation apparatus according to an embodiment of the present disclosure;

FIG. 3 to FIG. 6 are schematic diagrams of a structure of a power generation apparatus according to embodiments of the present disclosure; and

FIG. 7 is an overall schematic diagram of a power generation apparatus according to an embodiment of the present disclosure.

### DETAILED DESCRIPTION

Various exemplary embodiments of the present disclosure are described now in detail with reference to the accompanying drawings. It should be noted that unless otherwise specifically specified, the relative arrangements, numeric expressions, and values of the components and steps described in these embodiments do not limit the scope of the present disclosure.

The following descriptions of at least one exemplary embodiment are merely illustrative, and should not be construed as any limitation on the present disclosure and implementation or use thereof.

Techniques, methods and devices known to a person of ordinary skill in the relevant art may not be discussed in detail. However, where appropriate, the techniques, methods and devices should be considered as a part of the specification.

In all the examples shown and discussed herein, any specific value should be construed as merely an example and not as a limitation. Therefore, other examples of exemplary embodiments may have different values.

It should be noted that similar reference numerals and letters represent similar items in the following accompanying drawings. Therefore, once a specific item is defined in one of the accompanying drawings, no further discussion thereof is required in the subsequent accompanying drawings.

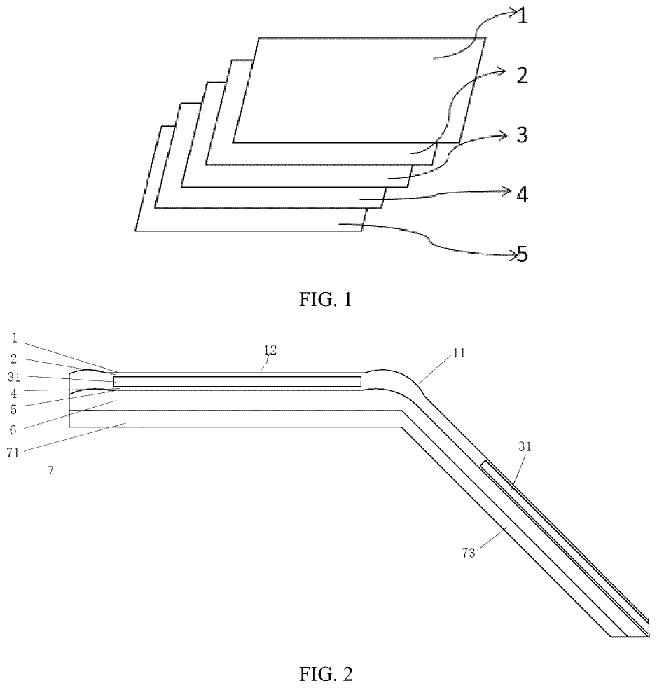

An embodiment of the present disclosure provides a battery assembly. As shown in FIG. 1 and FIG. 2, the battery assembly includes a first flexible material layer 1, a second flexible material layer 5, and a battery layer 3. The battery layer 3 includes a plurality of battery bodies 31 disposed at intervals. The battery layer 3 is located between the first flexible material layer 1 and the second flexible material layer 5. The first flexible material layer 1 and the second flexible material layer 5 form a flexible region 11 at a gap between adjacent battery bodies 31. The second flexible material layer 5 is configured to be connected to a component to be mounted. The flexible region 11 is adapted to a bent portion of the component to be mounted.

In this example, the first flexible material layer 1 and the second flexible material layer 5 are made of a flexible material. The first flexible material layer 1 and the second flexible material layer 5 can be bent to adapt to the bent portion of the component to be mounted. The battery bodies 31 may be photovoltaic material batteries, rechargeable batteries, or the like. The plurality of battery bodies 31 may be connected together in series, parallel, or other manners. The plurality of battery bodies 31 are sandwiched between the first flexible material layer 1 and the second flexible material layer 5. The battery body 31 is generally made of a rigid material and cannot be bent. The plurality of battery bodies 31 are arranged in an array. A gap is formed between adjacent battery bodies 31. At the gap, the first flexible material layer 1 and the second flexible material layer 5 form a flexible region 11. The flexible region 11 can be bent to adapt to the bent portion of the component to be mounted.

In this embodiment of the present disclosure, the battery assembly has a simple structure. When the battery assembly is mounted, the battery assembly can be directly attached to a surface of the component to be mounted without the need to provide an additional support to support the battery assembly. This reduces a weight of the battery assembly.

In addition, the battery assembly has a flexible region 11. In the flexible region 11, the first flexible material layer 1 and the second flexible material layer 5 can be bent, so that the battery assembly can adapt to the bent portion of the component to be mounted. This increases a contact area between the battery assembly and the component to be mounted. As such, a gap between the battery assembly and the component to be mounted is significantly reduced, making it less likely for the battery assembly to be suspended in mid-air. This enables connection between the battery assembly and the component to be mounted to be more secure.

In addition, the flexible region 11 can be cut, which allows the battery assembly to be set to an appropriate size according to actual requirements, so as to facilitate use of the battery assembly.

In addition, the flexible region 11 enables the battery assembly to be folded, so that the battery assembly can be accommodated in different configurations, which facilitates packaging and transport of the battery assembly.

In an example, as shown in FIG. 1 and FIG. 2, at least one of the first flexible material layer 1 or the second flexible material layer 5 is provided with a bonding layer on a side closest to the battery layer 3.

The bonding layer is configured to bond the first flexible material layer 1 and the second flexible material layer 5 to the battery body 31. In the flexible region 11, the bonding layer can also bond the first flexible material layer 1 and the second flexible material layer 5 together.

The bonding layer includes, for example, a first adhesive film layer 2 between the first flexible material layer 1 and the battery layer 3, and a second adhesive film layer 4 between the second flexible material layer 5 and the battery layer 3. Materials of the first adhesive film layer 2 and the second adhesive film layer 4 may be, but are not limited to, an ethylene-vinyl acetate copolymer (Ethylene Vinyl Acetate Copolymer, EVA) adhesive film, a polyolefin elastomer (Polyolefin Elastomer, POE) adhesive film, a polyvinyl butyral (Polyvinyl Butyral, PVB) adhesive film, a silicone adhesive film, a co-extruded EVA-POE adhesive film, or the like.

The bonding layer enables the first flexible material layer 1, the second flexible material layer 5, and the battery layer 3 to form an integral structure. In this manner, overall structural strength of the battery assembly can be effectively improved.

In other embodiments, the connection manner is not limited to bonding, and a person skilled in the art can select a connection manner according to actual requirements. For example, the first flexible material layer 1, the second flexible material layer 5, and the battery layer 3 may alternatively be connected together by using a wire or the like.

In an example, at least one of the first flexible material layer 1 or the second flexible material layer 5 includes at least one of a fiber material layer, a polymer layer, a glass layer, or a metal film layer.

In this example, a material of the fiber material layer may be at least one of glass fiber, carbon fiber, polyester fiber, or polyaramid fiber. The foregoing fiber material is prepared into a fiber prepreg, and then molded or combined with other layers.

A material of the polymer layer may be, but is not limited to, plastic, rubber, silicone, or the like. The polymer layer is easy to process, and has good ductility and bending properties. For example, in one embodiment, the material of the polymer layer is polyethylene glycol terephthalate (Polyethylene Glycol Terephthalate, PET). The material has excellent physical and mechanical properties in a wide temperature range. PET can be used at a temperature up to 120 °C and has excellent electrical insulation properties. At high temperature and high frequency, PET still has good electrical properties, but has poor corona resistance; and creep resistance, fatigue resistance, friction resistance, and dimensional stability are good.

The glass layer is generally ultra-thin glass. For example, a thickness of the ultra-thin glass is less than 0.1 mm. The ultra-thin glass has good bending properties.

The metal film layer is, for example, an aluminum film layer, a stainless steel film layer, or a copper film layer.

The foregoing materials can all be bent to adapt to the bent portion of the component to be mounted.

It should be appreciated by those of ordinary skill in the art that the first flexible material layer 1 and the second flexible material layer 5 are not limited to the foregoing embodiments, and a person skilled in the art can provide the first flexible material layer 1 and the second flexible material layer 5 according to actual requirements.

In an example, at least one of the first flexible material layer 1 or the second flexible material layer 5 includes a polymer layer, and the polymer layer includes a fluoropolymer.

A material of the fluoropolymer may be, but is not limited to, a fluoroplastic, for example, poly tetra fluoro ethylene (Poly Tetra Fluoro Ethylene, PTFE), ethylene tetra fluoro ethylene (Ethylene Tetra Fluoro Ethylene, ETFE), or ethylene chlorotri fluoro ethylene (Ethylene Chlorotri Fluoro Ethylene, ECTFE). The fluoropolymer has good temperature resistance and anti-aging properties.

In an example, the battery assembly further includes a reinforcing layer. The reinforcing layer is located between the first flexible material layer 1 and the battery body 31.

For example, the reinforcing layer is bonded to the first flexible material layer 1 and the battery layer 3. The first flexible material layer 1 is generally exposed to a usage environment and is susceptible to impact. The reinforcing layer can effectively improve structural strength of an exposed side of the battery assembly, thereby effectively improving durability of the battery assembly.

In an example, the reinforcing layer includes a fiber material layer. The fiber material layer has high structural strength, and can significantly improve structural strength of the battery assembly.

In an example, the first flexible material layer 1 and the reinforcing layer are made of the same material. This manner enables easy manufacturing of the battery assembly.

In an example, the battery assembly includes a plurality of reinforcing layers. The plurality of reinforcing layers are bonded together. In this manner, structural strength and durability of the battery assembly can be improved more effectively.

In an example, the battery body 31 is made of a photovoltaic material. The first flexible material layer 1 forms a functional region 12 at a position opposite to the photovoltaic material, and a light transmittance of the functional region 12 is greater than or equal to 80%.

In this example, the photovoltaic material is a material for generating electricity by using light. The photovoltaic material may be, but is not limited to, a material such as polysilicon, single crystal silicon, cadmium sulfide, gallium arsenide, or copper indium selenium. The functional region 12 is a region that can implement a function of the battery body 31, for example, photovoltaic generation. In this example, the light transmittance of the functional region 12 of the first flexible material layer 1 is greater than or equal to 80%. This significantly improves power generation efficiency of the battery assembly.

In an example, a thickness of at least one of the first flexible material layer 1 or the second flexible material layer 5 ranges from 0.2 mm to 0.5 mm.

For example, in one embodiment, the first flexible material layer 1 includes a glass fiber prepreg. A thickness of the glass fiber prepreg ranges from 0.2 mm to 0.5 mm. Within this range, the first flexible material layer 1 can withstand a hail impact, and has a light transmittance of 88% or more, and power generation efficiency of the battery assembly is high.

In an example, the battery body 31 is made of a photovoltaic material, a reflectivity of the flexible region 11 of the first flexible material layer 1 is greater than or equal to 80%, and the flexible region 11 is adapted to reflect light onto the photovoltaic material.

The photovoltaic material is as described above. In general, light irradiated to the flexible region 11 cannot be used to generate electricity. In this example, by setting the reflectivity of the flexible region 11 of the first flexible material layer 1 to 80% or more, light irradiated to the flexible region 11 can be reused to improve light intensity of the functional region 12, thereby improving the power generation efficiency of the battery assembly.

A person skilled in the art may set a setting angle of the flexible region 11, so that light irradiated to the flexible region 11 is reflected onto the photovoltaic material.

In an example, the flexible region 11 of the first flexible material layer 1 includes a base body layer and a reflective coating. The reflective coating is disposed on the base body layer.

The base body layer is, for example, at least one of the foregoing: a fiber material layer, polymer layer, glass layer, or metal film layer. The reflective coating can reflect sunlight effectively. A molecular structure of the reflective coating should contain as few energy-absorbing groups as possible, such as —C—O—C—, C═O, and —OH. For example, a material of the reflective coating may include, but is not limited to, at least one of acrylic resin, silicone-modified acrylic resin, alkyd resin, silicone-modified alkyd resin, fluorine-containing resin, epoxy resin, or chlorinated rubber. Alternatively, the reflective coating includes at least one of acrylic resin, silicone-modified acrylic resin, alkyd resin, silicone-modified alkyd resin, fluorine-containing resin, epoxy resin, or chlorinated rubber, and a mixture of at least one of titanium dioxide, talc, calcium carbonate, silicon dioxide, or metal powder. The metal powder is, for example, silver powder, copper powder, or aluminum powder. The reflective coating is disposed on the base body layer in a coating manner to form the first flexible material layer 1.

The material has good reflection properties, for example, has a reflectivity of 80% or more, thereby improving power generation efficiency of the battery assembly.

It should be appreciated that the first flexible material layer 1 is not limited to the foregoing embodiment, and a person skilled in the art can make a selection according to actual requirements.

In an example, a thickness of at least one of the first flexible material layer 1 or the second flexible material layer 5 ranges from 0.2 mm to 0.5 mm.

Within this range, the first flexible material layer 1 and the second flexible material layer 5 have good flexibility, light transmittance, and structural strength.

Another embodiment of the present disclosure provides a battery apparatus. The battery apparatus includes the foregoing battery assembly.

The battery apparatus has the characteristics of light weight, a simple structure, and high structural strength.

In an example, as shown in FIG. 2, the battery apparatus further includes a substrate 7. The substrate 7 includes a plurality of surfaces. A bent portion is formed between the plurality of surfaces. The battery bodies 31 are located on the plurality of surfaces. The flexible region 11 is located on the bent portion.

The substrate 7 is configured to mount the battery assembly. The substrate 7 may be, but is not limited to, a color steel plate. A person skilled in the art may set a size and a construction of the color steel plate according to actual requirements. The color steel plate is bent to form a plurality of surfaces. There is at least one bent portion between adjacent surfaces. The bent portion is a corner. The plurality of surfaces may be located at a same height or may be located at different heights. The plurality of surfaces may be parallel or intersect at a set angle. The surfaces may be planes or arc surfaces. The second flexible material layer 5 is bonded to the color steel plate in a bonding manner. An adhesive layer 6 is formed between the second flexible material layer 5 and the color steel plate.

For example, the adhesive layer 6 located between the plurality of surfaces and the second flexible material layer 5 can ensure that the battery body 31 is firmly bonded to and substantially disposed in parallel to a corresponding surface. The bent portion is generally susceptible to impact, and exhibits a stress concentration. The adhesive layer 6 located between the bent portion and the second flexible material layer 5 can ensure that the first flexible material layer 1, the second flexible material layer 5, and the bent portion form an integral structure, thereby improving durability of the battery assembly.

In this example, the battery apparatus has a simple overall structure, enabling the battery assembly to be connected to the substrate 7 to form an integral structure without requiring a support or the like.

In addition, the overall weight of the battery apparatus is light, and the durability is good.

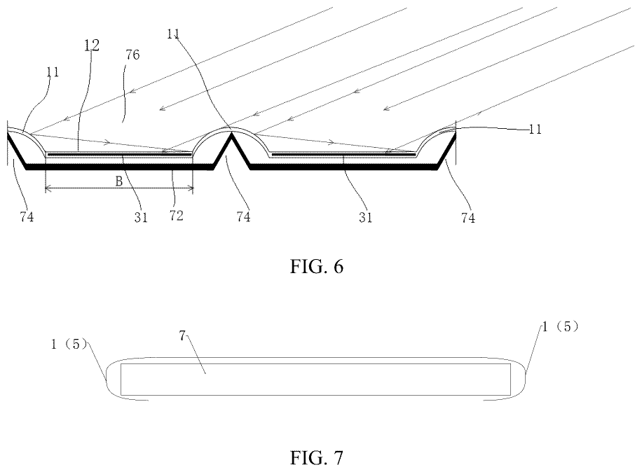

In an example, as shown in FIG. 6, a first protrusion portion 74 is formed between two adjacent surfaces. The first protrusion portion 74 includes a plurality of bent portions. The flexible region 11 covers the first protrusion portion 74. The flexible region 11 is spaced apart from the first protrusion portion 74.

In this example, the plurality of surfaces are located at the same height. The first protrusion portion 74 is formed between adjacent surfaces. A cross-section of the first protrusion portion 74 is arc-shaped, triangular, trapezoidal, rectangular, or the like. The entire flexible region 11 is located outside the first protrusion portion 74. In the flexible region 11, the second flexible material layer 5 and the first protrusion portion 74 are not bonded together, so that a gap is formed between the flexible region 11 and the first protrusion portion 74. That is, the entire flexible region 11 spans the first protrusion portion 74. In the functional region 12 of the first flexible material layer 1, the second flexible material layer 5 is bonded to the surface. This manner ensures a strong connection between the battery assembly and a base body.

In addition, the flexible region 11 may be configured according to actual requirements, so that light irradiated to the flexible region 11 can be reflected onto the photovoltaic material.

It should be appreciated by those of ordinary skill in the art that, in another example, the plurality of surfaces may alternatively be located at different heights.

In an example, as shown in FIG. 6, the flexible region 11 is of an arc surface structure. The entire arc surface structure is located outside the first protrusion portion 74. The arc surface structure has higher structural strength than a structure with a corner, and is less prone to stress concentration.

In addition, compared with an inclined surface, the arc surface structure can meet reflection requirements of light from different angles, so that more light is reflected onto the photovoltaic material.

In an example, as shown in FIG. 6, the functional region 12 of the first flexible material layer 1 is a composite layer of an ETFE layer, a PET layer, and a glass fiber layer. The ETFE layer is a surface layer and has a thickness of 20 μm. The glass fiber layer has a thickness of 400 μm. The PET layer has a thickness of 310 μm. The PET layer is located between the glass fiber layer and the ETFE layer. The ETFE layer, the PET layer, and the glass fiber layer are bonded with acrylic glue. This thickness enables the light transmittance of the first flexible material layer 1 to be 88% or more. The functional region 12 of the first flexible material layer 1 has a width (as shown by B in FIG. 6) of 185 mm.

The flexible region 11 of the first flexible material layer 1 is a composite layer of the ETFE layer and the PET layer. A cross-section of the flexible region 11 is an arc surface structure. The ETFE layer has a thickness of 20 μm. The PET layer has a thickness of 310 μm. The ETFE layer and the PET layer are bonded with acrylic glue. The first adhesive film layer 2 is a transparent EVA adhesive film. The second adhesive film layer 4 is a white EVA adhesive film. The flexible region 11 of the first flexible material layer 1 is provided with a reflective coating. The reflective coating is acrylic resin, and has a reflectivity of 80% or more. The flexible region 11 of the first flexible material layer 1 has a width of 190 mm. The adhesive layer 6 is silicone rubber.

For example, a solar elevation angle on the winter solstice in a certain place is 90° (31°11″+23°26″)=35°23″. By means of calculation, it is obtained that an included angle between the first protrusion portion 74 and a bottom surface 72 is 30° or 90°, and therefore, an included angle of 30° is selected.

It can be seen that, in this example, the flexible region 11 of the arc surface structure can effectively reflect light onto the battery body 31 of the bottom surface 72.

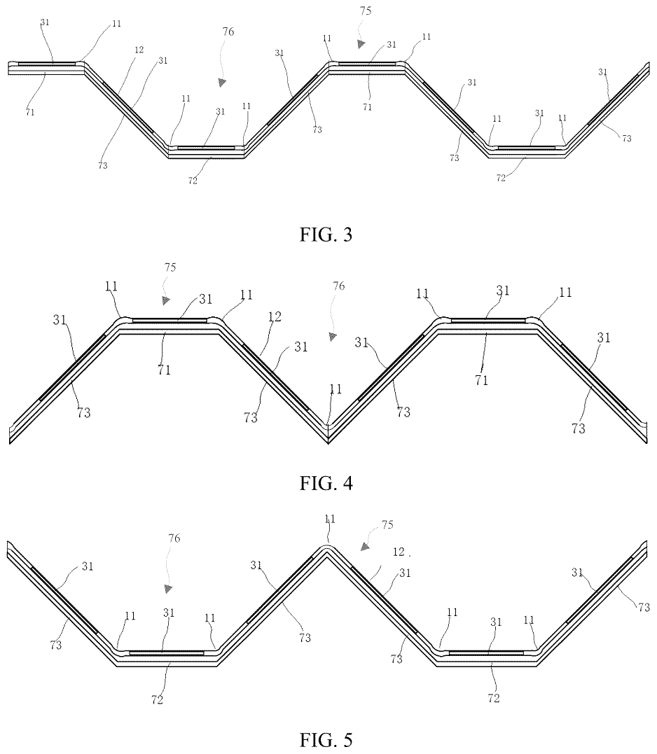

In an example, as shown in FIG. 3, the substrate 7 includes a second protrusion portion 75 and a recessed portion 76. The plurality of surfaces include a top surface 71 located on the second protrusion portion 75, a bottom surface 72 located at a bottom of the recessed portion 76, and a side surface 73 between the top surface 71 and the bottom surface 72. A connection between the top surface 71 and the side surface 73 and a connection between the bottom surface 72 and the side surface 73 separately form the bent portion. The battery layer 3 includes a plurality of battery bodies 31. The plurality of battery bodies 31 are respectively located on the top surface 71, the bottom surface 72, and the side surface 73.

In this example, the top surface 71 and the bottom surface 72 are parallel. The side surface 73 is inclined relative to the top surface 71 and the bottom surface 72. An included angle between the side surface 73 and the top surface 71 is an obtuse angle. An included angle between the side surface 73 and the bottom surface 72 is an obtuse angle. Cross-sections of the second protrusion portion 75 and the recessed portion 76 are both trapezoidal. The top surface 71, the bottom surface 72, and the side surface 73 are each provided with a battery body 31. The flexible region 11 corresponds to the bent portion. Both the functional region 12 and the flexible region 11 are bonded to the substrate 7.

In this manner, the connection strength between the battery assembly and the base body is high. Additionally, space utilization of the battery apparatus is high. The plurality of battery bodies 31 are respectively oriented in different directions, so that the capability of the battery assembly for receiving light is significantly improved.

In an example, as shown in FIG. 4, the substrate 7 includes a second protrusion portion 75 and a recessed portion 76. The plurality of surfaces include a top surface 71 located on the second protrusion portion 75 and a side surface 73 located on the recessed portion 76. A connection between the top surface 71 and the side surface 73 and a connection between two adjacent side surfaces 73 separately form the bent portion. The battery layer 3 includes a plurality of battery bodies 31. The plurality of battery bodies 31 are respectively located on the top surface 71 and the side surface 73.

In this example, a cross-section of the second protrusion portion 75 is trapezoidal, and a cross-section of the recessed portion 76 is V-shaped. An included angle between the side surface 73 and the top surface 71 is an obtuse angle. Cross-sections of adjacent side surfaces 73 have equal lengths. In this implementation, an included angle between adjacent side surfaces 73 is a right angle or an obtuse angle, so as to reduce mutual obstruction of light between two side surfaces 73.

Similarly, in this example, the connection strength between the battery assembly and the base body is high. Additionally, apace utilization of the battery apparatus is high. The plurality of battery bodies 31 are respectively oriented in different directions, so that the capability of the battery assembly for receiving light is significantly improved.

In an example, as shown in FIG. 5, the substrate 7 includes a second protrusion portion 75 and a recessed portion 76. The plurality of surfaces include a bottom surface 72 located at the bottom of the recessed portion 76 and a side surface 73 located on the recessed portion 76. A connection between the bottom surface 72 and the side surface 73 and a connection between two adjacent side surfaces 73 separately form the bent portion. The battery layer 3 includes a plurality of battery bodies 31. The plurality of battery bodies 31 are respectively located on the bottom surface 72 and the side surface 73.

In an example, the cross-section of the second protrusion portion 75 is an inverted V-shape, and the cross-section of the recessed portion 76 is trapezoidal. An included angle between the side surface 73 and the bottom surface 72 is an obtuse angle. Cross-sections of adjacent side surfaces 73 have equal lengths. In this implementation, an included angle between adjacent side surfaces 73 is a right angle or an obtuse angle, so that light is more effectively received.

In this example, the functional region 12 of the first flexible material layer 1 is a composite layer of an ETFE layer and a glass fiber layer. The ETFE layer is a surface layer and has a thickness of 20 μm. The glass fiber layer has a thickness of 400 μm. This thickness enables the light transmittance of the first flexible material layer 1 to be 88% or more. The functional region 12 of the first flexible material layer 1 has a width of 187 mm.

The flexible region 11 of the first flexible material layer 1 is an ETFE layer, and has a thickness of 20 μm. The flexible region 11 of the first flexible material layer 1 is provided with a reflective coating. The reflective coating is acrylic resin, and has a reflectivity of 90% or more. The flexible region 11 of the first flexible material layer 1 has a width of 8 mm.

The first adhesive film layer 2 and the second adhesive film layer 4 are EVA adhesive films. The second flexible material layer 5 includes a PET layer. The second flexible material layer 5 has a thickness of 310 μm. The base body is a color steel plate, for example, a height of the second protrusion portion 75 of the color steel plate is 135 mm, and a width of the bottom surface 72 is 195 mm. The battery apparatus further includes a junction box. The junction box is connected to the battery body 31. The junction box is located at the second protrusion portion 75. The adhesive layer 6 is made of silicone rubber.

In this implementation, the second flexible material layer 5 further includes a waterproof layer. For example, the waterproof layer is an aluminum film layer. The aluminum film layer is located outside the PET layer.

In this example, the connection strength between the battery assembly and the substrate 7 is high. Additionally, space utilization of the battery apparatus is high. The plurality of battery bodies 31 are respectively oriented in different directions, so that the capability of the battery assembly for receiving light is significantly improved.

In another example, the functional region 12 of the first flexible material layer 1 is a composite layer of an ETFE layer, a glass fiber layer, and a PET layer. The ETFE layer is a surface layer and has a thickness of 20 μm. The glass fiber layer has a thickness of 400 μm. The PET layer has a thickness of 310 μm. The first adhesive film layer 2 is a transparent EVA adhesive film. The second adhesive film layer 4 is a white EVA adhesive film. The second flexible material layer 5 is a PET layer and has a thickness of 310 μm.

In an example, edges of the first flexible material layer 1 and the second flexible material layer 5 can be bent to cover an edge of the substrate 7.

As shown in FIG. 7, the edges of the first flexible material layer 1 and the second flexible material layer 5 can be bent, and a bent portion wraps around the edge of the substrate 7 and extends to a surface of the substrate 7 that faces away from the battery layer 3. In this manner, in an aspect, a connection area between the battery assembly and the substrate 7 is effectively increased, thereby improving the bonding strength between the battery assembly and the substrate 7; and in another aspect, the battery assembly can protect the edge of the substrate 7, thereby improving durability of the battery apparatus.

An emphasis in the foregoing embodiments is to describe differences between the embodiments, and different optimization features between the embodiments may be combined to form better embodiments provided that there is no contradiction. For brevity, details are not described herein again.

Although some specific embodiments of the present disclosure have been described in detail by using examples, it should be understood by a person skilled in the art that the foregoing examples are merely for illustrative purposes, and are not intended to limit the scope of the present disclosure. It should be understood by a person skilled in the art that modifications can be made to the above embodiments without departing from the scope and spirit of the present disclosure. The scope of the present disclosure is defined by the appended claims.

### DESCRIPTIONS OF REFERENCE NUMERALS

1. First flexible material layer; 11. Flexible region; 12. Functional region; 2. First adhesive film layer; 3. Battery layer; 31. Battery body; 4. Second adhesive film layer; 5. Second flexible material layer; 6. Adhesive layer; 7. Substrate; 71. Top surface; 72. Bottom surface; 73. Side surface; 74. First protrusion portion; 75. Second protrusion portion; and 76. Recessed portion.

1. A battery assembly, comprising:
a first flexible material layer;
a second flexible material layer; and
a battery layer, wherein the battery layer comprises a plurality of battery bodies disposed at intervals, the battery layer is located between the first flexible material layer and the second flexible material layer,
wherein the first flexible material layer and the second flexible material layer form a flexible region at a gap between adjacent battery bodies of the plurality of battery bodies, and
wherein the second flexible material layer is configured to be connected to a component to be mounted, and the flexible region is adapted to a bent portion of the component to be mounted.

2. The battery assembly according to claim 1, wherein at least one of the first flexible material layer or the second flexible material layer is provided with a bonding layer on a side closest to the battery layer.

3. The battery assembly according to claim 1, wherein at least one of the first flexible material layer or the second flexible material layer comprises at least one of a fiber material layer, a polymer layer, a glass layer, or a metal film layer.

4. The battery assembly according to claim 1, wherein at least one of the first flexible material layer or the second flexible material layer comprises a polymer layer, and the polymer layer comprises a fluoropolymer.

5. The battery assembly according to claim 1, further comprising a reinforcing layer, wherein the reinforcing layer is located between the first flexible material layer and one or more of the plurality of battery bodies.

6. The battery assembly according to claim 5, wherein the reinforcing layer comprises a fiber material layer.

7. The battery assembly according to claim 1, wherein each battery body of the plurality of battery bodies is made of a photovoltaic material, the first flexible material layer forms a functional region at a position opposite to the photovoltaic material, and a light transmittance of the functional region is greater than or equal to 80%.

8. The battery assembly according to claim 1, wherein each battery body of the plurality of battery bodies is made of a photovoltaic material, a reflectivity of the flexible region of the first flexible material layer is greater than or equal to 80%, and the flexible region is adapted to reflect light onto the photovoltaic material.

9. The battery assembly according to claim 8, wherein the flexible region of the first flexible material layer comprises a base body layer and a reflective coating disposed on the base body layer.

10. The battery assembly according to claim 9, wherein the base body layer comprises at least one of a fiber material layer, a polymer layer, a glass layer, or a metal film layer.

11. The battery assembly according to claim 9, wherein the reflective coating comprises at least one of acrylic resin, silicone-modified acrylic resin, alkyd resin, silicone-modified alkyd resin, fluorine-containing resin, epoxy resin, or chlorinated rubber; or
the reflective coating comprises at least one of acrylic resin, silicone-modified acrylic resin, alkyd resin, silicone-modified alkyd resin, fluorine-containing resin, epoxy resin, or chlorinated rubber, and a mixture of at least one of titanium dioxide, talc, calcium carbonate, silicon dioxide, or metal powder.

12. The battery assembly according to claim 1, wherein a thickness of at least one of the first flexible material layer or the second flexible material layer ranges from 0.2 mm to 0.5 mm.

13. A battery apparatus, comprising:
a substate;
a battery assembly positioned relative to the substrate, the battery assembly comprising:
a first flexible material layer;
a second flexible material layer; and
a battery layer, wherein the battery layer comprises a plurality of battery bodies disposed at intervals, the battery layer is located between the first flexible material layer and the second flexible material layer,
wherein the first flexible material layer and the second flexible material layer form a flexible region at a gap between adjacent battery bodies of the plurality of battery bodies, and
wherein the second flexible material layer is configured to be connected to a component to be mounted, and the flexible region is adapted to a bent portion of the component to be mounted.

14. The battery apparatus according to claim 13, wherein the substrate comprises a plurality of surfaces, a bent portion is formed between the plurality of surfaces, the plurality of battery bodies are located on the plurality of surfaces, and the flexible region is located on the bent portion.

15. The battery apparatus according to claim 14, wherein a first protrusion portion is formed between two adjacent surfaces, the first protrusion portion comprises a plurality of bent portions, and the flexible region covers the first protrusion portion.

16. The battery apparatus according to claim 14, wherein the flexible region is of an arc surface structure.

17. The battery apparatus according to claim 14, wherein the substrate comprises a second protrusion portion and a recessed portion, the plurality of surfaces comprise a top surface located on the second protrusion portion, a bottom surface located at a bottom of the recessed portion, and a side surface between the top surface and the bottom surface, wherein a connection between the top surface and the side surface and a connection between the bottom surface and the side surface separately form the bent portion, wherein the plurality of battery bodies are respectively located on the top surface, the bottom surface, and the side surface.

18. The battery apparatus according to claim 14, wherein the substrate comprises a second protrusion portion and a recessed portion, the plurality of surfaces comprise a top surface located on the second protrusion portion and a side surface located on the recessed portion, wherein a connection between the top surface and the side surface and a connection between the side surface and an adjacent side surface separately form the bent portion, wherein the plurality of battery bodies are respectively located on the top surface and the side surface.

19. The battery apparatus according to claim 14, wherein the substrate comprises a second protrusion portion and a recessed portion, the plurality of surfaces comprise a bottom surface located at a bottom of the recessed portion and a side surface located on the recessed portion, wherein a connection between the bottom surface and the side surface and a connection between the side surface and an adjacent side surface separately form the bent portion, wherein the plurality of battery bodies are respectively located on the bottom surface and the side surface.

20. The battery apparatus according to claim 13, wherein edges of the first flexible material layer and the second flexible material layer can be bent to cover an edge of the substrate.

21. The battery apparatus according to claim 13, wherein the substrate comprises a color steel plate.
